(19) United States
(12) Patent Application Publication
(10) Pub. No.: US 2006/0027272 A1
(43) Pub. Date: Feb. 9, 2006

(54) Gas shut-off valve assembly

(76) Inventors: Jeremy John Tomlinson, North Vancouver (CA); John Jianyue Shen, Surrey (CA); Zuomin Dong, Victoria (CA)

Correspondence Address: GOWLING LAFLEUR HENDERSON LLP, P.O. BOX 49122, 2300-1055 DUNSMUIR ST., VANCOUVER, BC, V7X 1J1, CA

(21) Appl. No.: 10/910,602

(22) Filed: Aug. 4, 2004

(51) Int. Cl. F17D 1/00

(52) U.S. Cl. 137/881

(57) ABSTRACT

This invention relates to a valve assembly for metal hydride hydrogen storage (MHHS) or chemical hydride hydrogen storage (CHHS) devices. The valve assembly comprises a body with an inlet connector for connecting to the MHHS or CHHS device, an outlet connector for connecting to an external device, a cavity in the body that is in gas communication with the inlet and outlet connectors, and a shut-off valve in the cavity that can be moved between an opened position that permits gas flow between the inlet and outlet connectors, and a closed position that denies said gas flow. The outlet connector has a first valve therein that is biased to remain closed when external pressure thereon is less than or equal to ambient pressure, thereby impeding at least atmospheric gas backflow into the cavity. The outlet connector can also have a second, one-way valve that permits gas flow out of the valve assembly only, as well as a bypass mechanism including a gas passage coupled to the cavity and upstream of the first and second valves, through which gas can be transmitted to the canister during charging.

### FIELD OF THE INVENTION

This invention relates generally to a gas shut-off valve assembly, and in particular, to a shut-off valve assembly for a gaseous pressure vessel, such as a metal hydride hydrogen storage (MHHS) or a chemical hydride hydrogen storage (CHHS) canister.

### BACKGROUND OF THE INVENTION

Hydrogen Storage

Today, a major obstacle to the wide use of highly efficient and zero-emission fuel cells, especially for portable applications, is the lack of a safe, convenient and economical hydrogen storage device and supply system.

Hydrogen is naturally a gas at ambient temperatures. There are generally three ways in which hydrogen is stored: compressed gas, liquefaction, and solid storage by absorption into another substance. The primary conventional technologies for storing hydrogen are compressed and liquid hydrogen storage tanks. Compressing hydrogen gas is the most common storage method. However, very high storage pressures are necessary to store practical amounts of hydrogen. Storage pressures are usually between 2,000 to 5,000 pounds per square inch (PSI). While storage tanks of up to 10,000 PSI have been developed, the cost of compressing hydrogen to these pressures is high. Compressed hydrogen storage tank systems generally have a 2 weight percent (or wt. %) of hydrogen gas at 5,000 PSI and 4 weight percent at 10,000 PSI. Liquefaction of hydrogen is done by cooling the hydrogen gas to the point where it becomes a liquid (−253° C. or −423° F.). While this technique offers reasonable storage density, it requires maintenance of this low temperature and the need to manage the boil off vapor during periods of non-use. It is also very expensive to cool the hydrogen to the temperatures required for liquefaction. Liquid hydrogen storage tanks generally have a 5 wt. % of hydrogen gas.

Solid hydrogen storage generally utilizes a variety of alloys of metals, or metal hydrides, to absorb and release hydrogen. There is also activity at the laboratory stage in utilizing various novel forms of carbon to store hydrogen. Solid hydrogen storage technologies offers very good volumetric density of storage but can have challenges related to weight of the storage system or the operating temperature of the storage media. Metal hydrides operating at room temperature have a weight percent of hydrogen between 1.4 and 1.8. At higher temperatures (above 100° C.) some alloys can have weight percent above 4. Metal hydride hydrogen storage operates at relatively low pressure, normally below 100 PSI, depending upon the operating temperature and the composition of the alloys.

The relatively low operating pressure of metal hydride hydrogen storage devices as well as their limited hydrogen release rate make metal hydride safer hydrogen storage devices than compressed gas or liquid tanks, particularly for portable and mobile applications. This technology can be applied whenever hydrogen storage and distribution are needed. However, the low operating and temperature-sensitive pressure of this hydrogen storage device also creates a unique problem in its use—the potential of gas back-flow. When the amount of hydrogen left in the metal hydride hydrogen storage device drops to a certain low level, or when the environment temperature drops down below certain level, or a combination of both, the pressure inside the storage device may fall below the pressure inside a pipeline or other apparatus coupled to the storage device, thereby creating a negative pressure differential. This negative pressure differential will suck the air or other gases in the pipeline and the dead space within the valve back into the metal hydride hydrogen storage device. This back-flow not only introduces impurity to the stored hydrogen gas, it also poses a potential safety hazard. Therefore, it is desirable to avoid gas back-flow in MHHS devices, such as MHHS canisters. A backflow risk can also exist when the storage device is unconnected and the shut off valve is not completely closed, i.e. when the pressure inside the storage device drops below ambient pressure, thereby creating a negative pressure differential.

Although typically operating at a relatively low pressure, the pressure of the hydrogen stored inside the MHHS device tends to fluctuate under extreme temperature changes during charging; it is desirable for the pressure inside the storage device to stay below a threshold level for safe operation.

Pressurized Gas (Hydrogen) Shut-Off Valve

Many shut-off valves for pressurized gas applications, such as hydrogen, are in use today. To ensure secure complete shut-off of pressurized gas flow, a self tightening valve design is commonly used. Most of the existing valve designs either have a screw down valve, such as a screw down needle valve as shown in FIG. 1 (PRIOR ART), or a ball valve configuration as shown in FIG. 2 (PRIOR ART).

The needle valve design has a fine, tapered valve head that is pushed into a matching tapered hole when screwed tight in close. A typical design is represented by the Taper Seal Needle valves by High Pressure Equipment Company (http://www.high-pressure.com/index.asp). The needle valve is screwed down to close the valve and screwed up to allow the compressed gas to flow through the opening between the needle valve and the valve seat. Alternatively, the valve head can have the shape of a disc or cylinder that is pressed down over a small hole to seal the gas passage. Such a cylinder block and hole shut-off valve design is disclosed in U.S. Pat. No. #5,832,947, (issued 10 Nov. 1998 to Niemczyk). Other known designs use a ball, instead a disc, to block the hole, such as a design disclosed in U.S. Pat. No. #6,123,102, (issued 26 Sep. 2000 to Loegel). The advantages of the screw down valve include establishing a tight seal when tightened, and a consistent quality of the seal that is not influenced by the wear of the valve and thermal expansion/contraction caused by temperature variations. Any change of valve geometry can be compensated by the tightening screw. The drawback of the screw down valve is its inability to indicate the open-closed status of the valve during operation, thereby presenting a risk for undetected gas leaks.

The ball valve design is also used for pressurized gas applications, in particular, when the pressure of the gas is not extremely high. The valve has a holed ball sitting in a spherical cavity. By rotating the ball and the gas channel inside the ball, a passage for the pressurized gas is opened or closed. The ball valve is sealed by a second mechanism. Screw or spring forces are normally used to compress the two half spherical ball cavities together to ensure the seal. Frequently, either the ball valve or the ball seat cavity is made of an elastic material to ensure the seal and to reduce the required geometric accuracy of the spherical valve components. An example of a ball shut-off valve is the 3-Piece Swing-Out Stainless Steel Ball Valve produced by Parker Hannifin Corp. of Otsego, Mich. (http://www.parker.com).

The advantage of this ball valve configuration is its ability to show the open-or-close status of the valve. The valve will not be mistakenly left opened or partially-opened undetected. In addition, the structure of the valve ensures a blow-out proof design. The drawback of the ball valve configuration is a difficulty in establishing a consistent, tight seal. Small leaks may occur under wear, or be caused by different thermal expansions under temperature change when the ball valve and seat cavity are made of different materials.

Both needle valves and ball valves can be used as shut-off valves for pressurized vessels. For safety reasons, such shut-off valves are required to be remain closed when the canister and the valve are freely dropped from certain height. Neither of these valve designs are particularly suitable for MHHS canister use; for example, neither design prevents contamination from atmospheric gas backflow when the shut-off valves are accidentally left open when the MHHS canisters are not in use.

### SUMMARY OF THE INVENTION

A general objective of the invention is to provide an improved shut-off valve assembly for pressurized gas flow. Another general object of the invention is to provide a pressurized gas storage device having an improved shut off valve assembly. A particular objective of the invention is to provide a valve assembly for MHHS or CHHS devices that is resistant to gas back flow into the canister. Another particular objective of the invention is to provide a valve assembly for portable or transportable MHHS or CHHS canisters that has compact and light-weight components, and is user friendly and resistant to user abuse.

According to one aspect of the invention, there is provided an improved gas shut-off valve assembly that comprises:
(a) a body having a cavity therein;
(b) an inlet connector on the body and in gas communication with the cavity, the inlet connector being connectable to a pressurized gas storage device;
(c) an outlet connector on the body and in gas communication with the cavity, the outlet connector including a first valve biased to remain closed when external pressure thereon is less than or equal to ambient pressure, thereby impeding at least atmospheric gas backflow into the cavity; and
(d) a shut-off valve located inside the cavity that is movable between an opened position that permits gas flow between the inlet and outlet connectors, and a closed position that denies gas flow between the inlet and outlet connectors.

This valve assembly can be attached to a MHHS device or a CHHS device, or an integrated gas storage apparatus can be manufactured having a MHHS or CHHS device and the valve assembly. The valve assembly is particularly useful for use with a MHSS canister, as metal hydride storage devices have a tendency to act like a suction pump under certain circumstances. Generally speaking, the MHHS canister has an alloy that can absorb and hold large amounts of hydrogen by bonding with hydrogen and forming hydrides. The hydrogen storage alloy is capable of absorbing and releasing hydrogen without compromising its own structure. The hydrogen storage alloy releases heat when absorbing hydrogen and absorbs heat when releasing hydrogen. Conversely, cooling the alloy will cause it to absorb hydrogen and heating it will cause it to release hydrogen. While a typical MHHS canister can be designed to release hydrogen at around 30-60 PSI during normal operation at ambient temperature, the canister will cool as it releases hydrogen. Without adding heat, the hydrogen release will slow down or even stop. If the environment temperature of the canister falls below a certain level (depending upon the alloy), or if the canister is cooled, the pressure within the canister will drop below ambient pressure and the canister will thus act as a suction pump and cause gas backflow into the canister. In such circumstances, care must be taken with an MHHS canister equipped with a conventional shut-off valve to ensure that the valve is fully closed to prevent backflow of gases and other contaminants into the canister. The valve assembly of the present invention is particularly advantageous as it prevents gas backflow even if the shut-off valve in the assembly is left open, as the outlet connector valve prevents gases at ambient pressure or lower from entering into the MHHS canister via the valve assembly.

The outlet connector valve in the valve assembly can be configured to open upon application at a specific external pressure that is greater than ambient pressure, wherein such specific external pressure is higher than the internal operating pressures of external devices that are intended to connect to the outlet connector, e.g. a hydrogen combustor. When so configured, the outlet connector valve prevents backflow of the gases and contaminants inside a connected external device that is operating at a higher-than-ambient pressure.

The outlet connector can further comprise a quick connect-detach mechanism, which enables quick canister changes with the external device. The outlet connector can have a second valve located in the gas flow pathway between the first valve and the cavity, wherein the second valve is a one-way valve that allows gas flow out of the valve assembly only. When the quick connect-detach mechanism connects to an external device having a matching quick connect-detach connector and the first valve is locked into an open position thereby resulting in two-way flow therethrough, the second, one-way valve is operable to prevent gas back flow from the connected device into the MHHS canister. An additional valve mechanism can be added to bypass this one-way valve to allow hydrogen gas to flow into the canister for MHHS device charging.

The valve assembly can also comprise a spring biasing the shut-off valve against the cavity thus establishing a fluid seal therebetween. The spring provides a self tightening aspect to the valve assembly, thereby reducing the chance of gas leak.

The shut-off valve can have a circular cross-section with an axis around which the valve is rotatable between the opened and closed position. Such a valve can have a conical or frusta-conical shape with an axis coaxial with the rotation axis; in such case, at least part of the cavity has a shape that corresponds to the shut-off valve shape. Either the narrow or wide end of the frusta-cone can face upstream of the gas flow. The latter configuration is particularly advantageous as the pressurized gas flow against the wide end of the valve provides an additional means to the spring for ensuring a gas-tight seal between the valve and cavity surfaces.

Alternatively, the shut-off valve can have a generally spherical shape; in such a case, at least part of the cavity has a shape corresponding to the shut-off valve shape. Or, the shut-off valve can have a generally cylindrical shape with an axis coaxial to the rotation axis, and at least part of the cavity has a shape corresponding to the shut-off valve shape.

The valve assembly can further comprise a knob that is attached to the shut-off valve and that can be manipulated to rotate the shut-off valve. The knob can be marked to indicate when the shut-off valve is in an opened or closed position, thereby ensuring that an operator can easily determine the position of the shut-off valve at any time. The knob can be surrounded by a guard extending there around, thereby protecting the knob from damage and the valve from accidental opening upon impact, e.g. from the valve assembly and canister being dropped.

The valve assembly can further comprise a pressure relief device on or mounted to the body and which is in gas communication with the inlet connector. The pressure relief device can be a burst disk, or rupture disc, that is designed to burst when the pressure inside the valve assembly exceeds a threshold pressure. Or, the pressure relief device can be a spring-loaded valve calibrated to open when the pressure inside the valve assembly exceeds a threshold pressure.

The pressure relief device can be in gas communication with a part of the cavity between the shut-off valve and the inlet connector, thereby being in continuous gas communication with the inlet connector. Or, the shut-off valve can further include a groove extending along the surface of the valve. The groove can be aligned with the pressure relief device and inlet connector to provide continuous gas communication there between.

The outlet connector and pressure relief device can be either on or mounted to the side of the body, and the shut-off valve rotation axis can be vertical. Alternatively, the outlet connector can be on or mounted to the top of the body, the pressure relief device on or mounted to the side of the body, and the shut-off valve rotation axis can be horizontal. Also, the outlet connector and pressure relief device can be on or mounted to the side of the body, and the shut-off valve rotation axis can be horizontal.

### BRIEF DESCRIPTION OF THE DRAWINGS

In these Figures, the bottom of the illustrated apparatuses is hereby defined as the portions of the apparatuses having an inlet connector for connecting to a MHHS canister. However, it is to be understood that directional terms such as “top”, “bottom”, and “upwards” are used in the following description are for the purpose of providing relative reference only, and are not intended to suggest any limitations on how any apparatus is to be positioned during use.

FIG. 1 is a schematic side cut-away view of a needle-type shut-off valve (Prior Art).

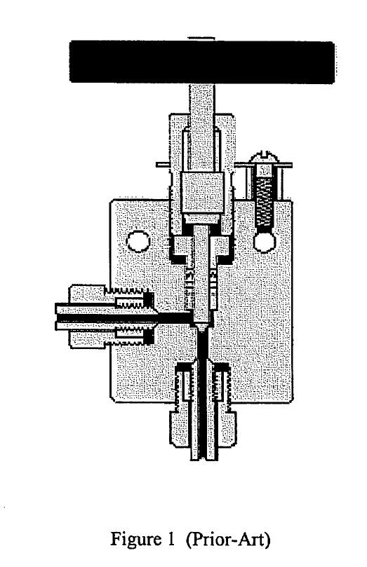

FIG. 2(a) is a photograph of a ball-type shut-off valve, and FIG. 2(b) is a schematic transparent perspective view of same. (Prior Art).

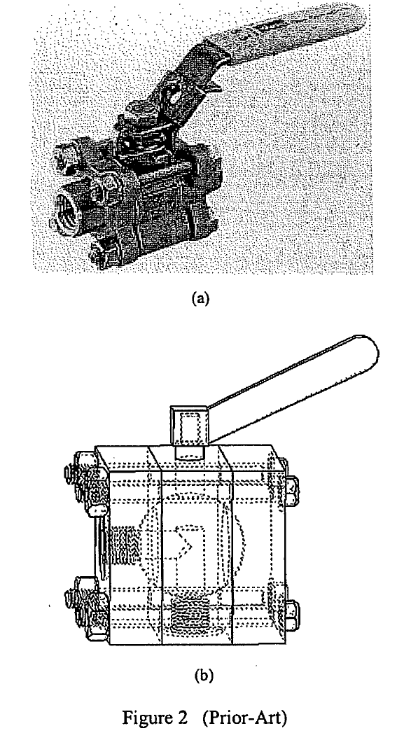

FIG. 3 is a schematic transparent perspective view of a valve assembly according a first embodiment of the invention, and which has a downwardly tapering frusta-conical gas shut-off valve with a rotatable control knob, a one-way quick-connect/detach outlet connector, a spring-loaded pressure relief device, and an inlet connector connected to a MHHS canister.

FIG. 4 is a schematic cut-away side view of the valve assembly shown in FIG. 3.

FIG. 5 is a schematic exploded perspective view of the valve assembly of FIG. 3 with a burst disc serving in place of a spring-loaded pressure relief device.

FIG. 6 is a schematic cut-away side view of the valve assembly of FIG. 3 having a burst disc pressure relief device in place of a spring-loaded pressure relief device.

FIGS. 7(a) and (b) are schematic transparent perspective and cut-away side views of a valve assembly according to a second embodiment of the invention, and which has an upwardly tapering frusta-conical gas shut-off valve with a rotatable control knob, a one way quick-connect/detach outlet connector, a burst disc pressure relief device, and an inlet connector for connecting to a MHHS canister.

FIG. 8(a) is a schematic exploded perspective view of a valve assembly according to a third embodiment of the invention, and which has a generally spherical gas shut-off valve with a side-mounted rotatable control knob, a top-mounted one-way quick-connect/detach outlet connector, a side mounted pressure relief device, and an inlet connector for connecting to a MHHS canister. FIGS. 8(b) and 8(c) are a pair of side cut-away views of the valve assembly shown in FIG. 8(a).

FIG. 9(a) is an exploded perspective view of a valve assembly according to a fourth embodiment of the invention, and which has a cylindrical gas shut-off valve with a side-mounted rotatable control knob, a top-mounted one-way quick-connect/detach outlet connector, a side mounted pressure relief device, and an inlet connector for connecting to a MHHS canister FIGS. 9(b) and 9(c) are a pair of side cut-away views of the valve assembly shown in FIG. 9(a)

FIGS. 10(a) to (c) are a schematic transparent perspective view and a first and second side cut-away views of a fifth embodiment of the invention, and which has a frusta-concial grooved shut-off valve with a top-mounted rotatable control knob, a one way quick-connect/detach outlet connector, an opening for receiving a pressure relief device, and an inlet connector for connecting to a MHHS canister.

FIGS. 11(a) and (b) are a schematic exploded side view and a schematic cut-away side view of a sixth embodiment of the invention, and which has a frusta-conical gas shut-off valve with a side-mounted rotatable control knob, a side-mounted one way quick-connect/detach outlet connector, a side mounted pressure relief device, and an inlet connector for connecting to a MHHS canister.

FIGS. 12 (a) to (c) are a schematic transparent perspective view and a pair side cut-away views of a valve assembly according to yet another embodiment invention and which has a frusta-conical grooved valve, a side mounted knob, a top mounted outlet connector and a side mounted pressure relief device.

FIG. 13(a) is a schematic side cut-away view of one embodiment of a quick-connect/detach outlet connector having a single valve, and FIG. 13(b) is a schematic side cut-away view of a second embodiment of a quick-connect/detach connector having two valves.

### DETAILED DESCRIPTION OF EMBODIMENTS OF THE INVENTION

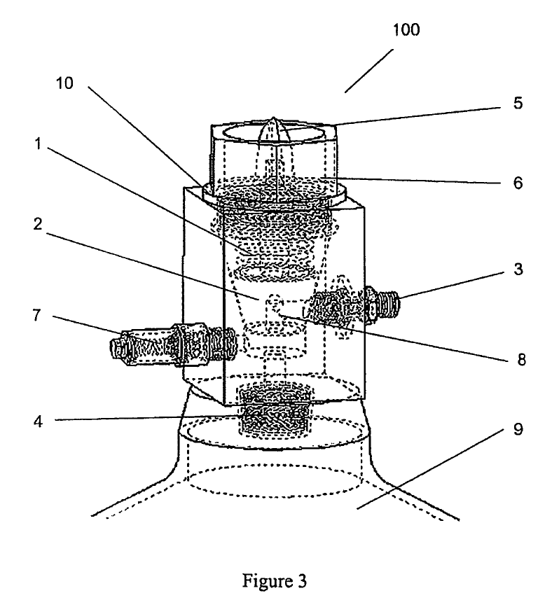

According to a first embodiment of the invention and referring to FIGS. 3 to 6, a valve assembly 100 is provided that comprises four major components, namely: a rotatable gas shut-off valve 2, a quick-connect/detach outlet connector 3, a safety pressure relief device 7, and a bottle/canister inlet connector 4.

Directional terms such as “top”, “bottom”, and “side” used in reference to the assembly 100 are based on the inlet connector 4 being hereby defined as being at the “bottom” of the assembly 100. However, it is to be understood that such directional terms are used merely for convenient reference to assist in the description of the assembly 100, and are not to be construed as limiting the orientation of the assembly 100 in use or in connection to any other structure.

The shut-off valve 2 has a frusta-conical shape and is seated with its narrow end facing the bottom of a matching frusta-conical cavity and towards the inlet connector 4, i.e. upstream of the gas flow. Alternatively, the cavity and valve 2 can both be conical (both not shown). The cavity is located within a valve assembly body 10 and has a top opening at the top of the body 10. Extending from the wide end of the valve 2 is a control knob 5. A compression spring 1 biases the valve 2 against the cavity's side wall to maintain a fluid seal therebetween. The cavity top opening is closed by a knob guard 6, which is fastened to the top of the body 10 by mating threads 20 on both the guard 6 and body 10; alternatively, the knob guard 6 can be attached to the body 10 by other suitable means such as bolting or welding. The guard 6 has a base with a central opening through which the knob 5 extends, and a side wall extending upwards from the base and around the knob 5. The inlet connector 4 is located at the bottom of the body 10, and a gas conduit 11 extends from the inlet connector 4 to the bottom of the cavity. Also, the body 10 has a first side opening for receiving the outlet connector 3, and a second side opening for receiving the pressure relief device 7. The first side opening extends from the outer surface of the body 10 to a part of the cavity's side wall that is in contact with the valve 2; the second side opening extends from the outer surface of the body 10 to a bottom part of the cavity 21 that is not in contact with the valve 2. The valve 2 has an “L” shaped gas passage 8 that extends from the narrow end of the valve 2, upwards into the valve's body, then outwards to the valve's side wall. The valve 2 can be rotated by rotating the knob 5 such that the gas passage 8 is aligned with the first side opening and thus provide a gas pathway from inlet connector 4 to the first side opening, i.e. to the outlet connector 3 (“open position”); when the gas passage 8 is not so aligned then gas cannot travel from the inlet connector 4 to the outlet connector 3 and the valve assembly 100 is in a closed position.

The inlet connector 4 extends downwardly from the bottom of the body 10, and is threaded on its outside surface, i.e. is a male connector. This design enables the inlet connector 4 to be screwed directly into a MHHS bottle 9 having a matching female connector, thereby providing a relatively compact assembly 100 and bottle 9 combination. Alternatively, the inlet connector could be a female connector to be screwed directly onto a MHHS bottle with a matching male connector. Alternatively, the inlet connector 4 can be attached to the bottle 9 by other means, such as welding or swaging. Alternatively, the body of the valve assembly 10 and the body of the canister 9 can be made in one piece in a manufacturing process, such as casting, forging and molding. In such case, no inlet connector is required.

A gas filter (not shown), such as a wire mesh or porous metal disc or insert, is used between the valve assembly 100 and the canister 9 to stop particles of the metal hydride materials escaping from the canister 9.

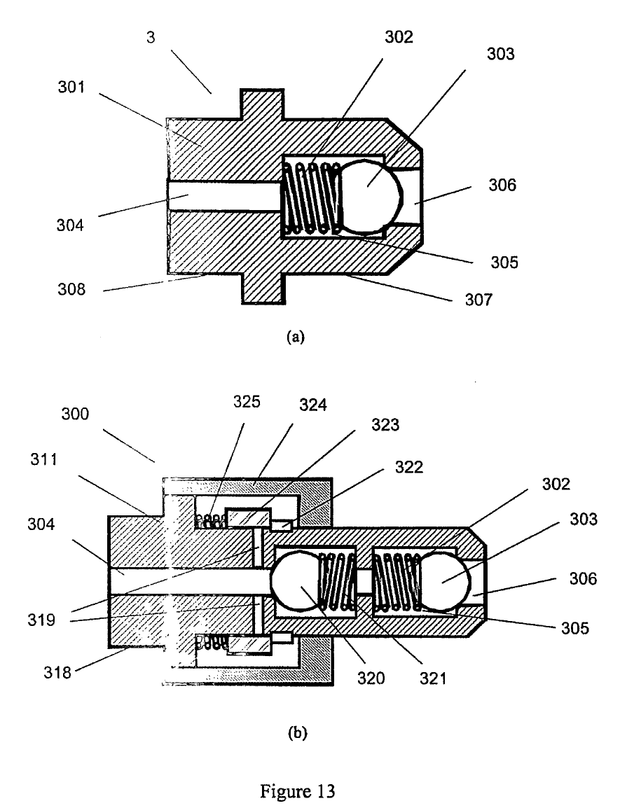

The outlet connector 3 has a quick-connect/detach design. Referring to FIG. 13(a), the outlet connector 3 can be used to quickly couple the hydrogen canister 9 to an external device (e.g. a fuel cell stack, not shown) via the valve assembly 100. The outlet connector 3 has a body with a gas passage 304 extending therethrough and to an outlet opening 306; inside part of the passage 304 is a valve cavity 305 that houses a spring ball valve 303 biased shut against the opening 306 by a spring 302. The body 301 has at its proximal end, a threaded portion 308 for connecting to the valve body 10; alternatively, the body 301 of the outlet connector 3 can be an integral part of the body of the valve assembly. At the distal end of the body 301 is a male quick detach portion 307 for coupling to a matching female quick detach connector (not shown) of the external device. Optionally, a sleeve (not shown) having a diameter larger than the connector body 301 can be attached around the outlet connector 3 to protect the body of the valve 301, and to convert the outlet connector 3 into a female connector, i.e. a male connector of the external device can now connect to the outlet connector 3 by inserting into the sleeve.

When the outlet connector 3 is a male connector and is coupled to a matching female connector, a rod in the female connector pushes the ball spring 303 into an opened position, thereby enabling gas flow through the outlet connector 3. The stiffness of the spring 3 is selected to at least resist deflection by ambient pressure. When uncoupled, the ball valve will thus stay closed under external atmospheric pressure, thereby preventing atmospheric gases from flowing into the valve assembly 100, even when the pressure in the canister 9 is below ambient pressure, forming a self-sealing mechanism. Preferably, the spring stiffness can be selected be compliant enough to be easily deflected by attachment of the female quick-connect/detach connector, but stiff enough to resist deflection by the operating pressure inside the external device coupled to the valve assembly and any “negative pressure” (i.e. lower than ambient pressure) expected within the canister 9. That is, the stiffness of the spring is selected based on the MHHS alloy and its potential low operating temperature, which determine the potential maximum suction pressure of canister. For example, the spring stiffness can be selected to resist deflection at up to 3 BAR, which would prevent backflow from gases inside a coupled hydrogen consuming device operating at up to 3 BAR.

Such back-flow tends to be an issue for pressure vessels having a relatively low pressure. For example, when the temperature of the pressure vessel drops to certain level, the gas pressure inside the vessel may be lower than the gas pressure in a device coupled to the vessel (or less than ambient pressure if the vessel is uncoupled but the outlet connector 3 is open by a connected female connector), causing a back flow of gas and air into the vessel. The valve assembly 100 is particularly effective when combined with MHHS canisters, as the hydrogen storage alloy in such canisters can absorb or discharge hydrogen depending on the temperature and pressure of the canister 9. Should the canister temperature drop below a certain threshold temperature that the hydrogen storage alloy switches to absorption mode, the one-way valve in the outlet connector 3 prevents a gas backflow from the device attached to the outlet connector 3.

Alternatively, and referring to FIG. 13(b), a two-valve outlet connector 300 can be substituted for the one-valve outlet connector 3 in the valve assembly 100. This two-valve outlet connector 300 is similar to the one-valve design, except for the following modifications:
1) A one way flow valve comprising ball valve 320 and spring 321 is added in the gas flow path between the first valve 303 and the gas passage 304. This addition prohibits the backflow of gas from the outlet 306 to the gas passage 304 no matter whether the female connector is connected to the outlet connector 300 or not. (The outlet connector 3 as shown in FIG. 13 (a) is open to two-way flow when the female connector is coupled and thus cannot prevent the backflow of gas when it is connected to the female connector).
2) A bypass mechanism for gas flow is introduced by a sealing ring 323 axially slidable over a valve body 311, a pair of gas channels 319 extending from the gas passage 304 to the surface of the valve body 311 and a spring 325 biasing the ring 323 over and sealing shut the gas channels 319. Also, a stopper 322 is provided to keep the ring in position over the gas channels 319.

Under normal working conditions, the bypass mechanism is disabled and the outlet connector 300 operates to discharge gas from the canister 9 to a coupled external device. The spring 321 does not prohibit pressurized gas flow from gas passage 304 to gas outlet 306. On the other hand, when gas pressure at outlet 306 is higher than that at the gas passage 304, the valve 320 closes and prevents the backflow of gas. A protective cover 324 is provided over the bypass mechanism; the cover 324 can be removed and a female charging connector (not shown) can be coupled to the outlet connector 300; the charging connector pushes the ring 323 back against the spring 325 and opens the gas channels 319 to gas flow. Pressurized gas flow can thus travel from the charging connector to the canister 9 via gas channel 319 and gas inlet 304, thereby by passing valves 303 and 320 and charging the canister 9.

Alternatively, the compression spring 321 can be replaced by a torsion/twisting spring and the ring 323 can include holes therethrough that can be rotated into alignment with the gas passages 319 to allow gas communication therethrough. Therefore, the female connector can be engaged with the ring 323 and twisted to rotate the ring holes into alignment with the gas passages 319.

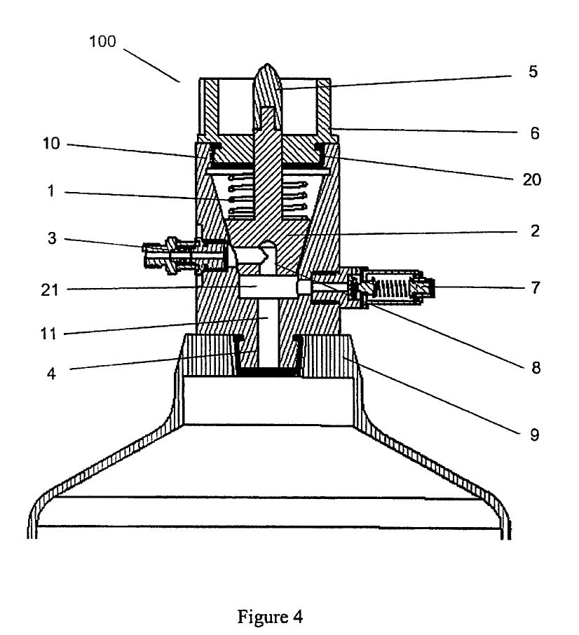

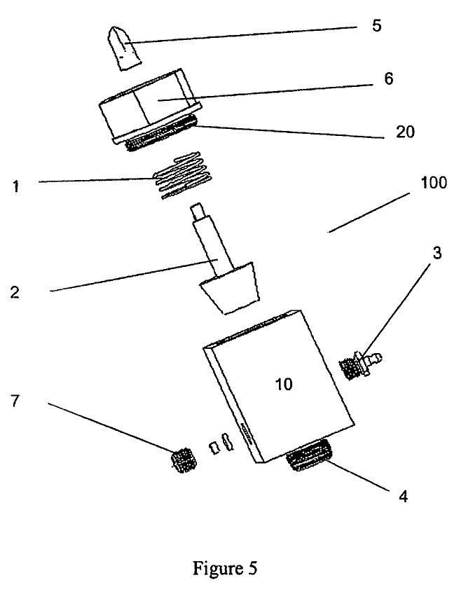

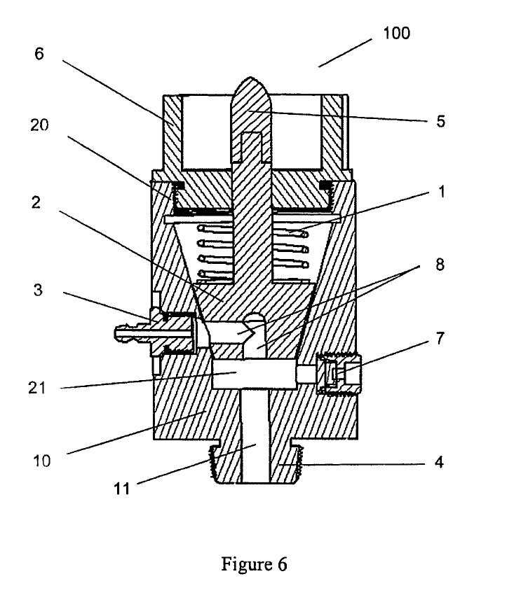

Pressure relief devices are used in pressure vessels to allow excessive pressure therein to be released, thereby avoiding explosions and other undesirable consequences. As the pressure relief device 7 is in continuous gas communication with the cavity, its operation is independent of the position of the valve 2. In this embodiment, the pressure relief device 7 can be a simple burst disc that fractures to relieve compressed gas when the pressure of the gas goes beyond the designed strength of the disc; see for example, FIGS. 5 and 6. Or, the pressure relief device 7 can be a spring-loaded pressure relief valve that uses factory-set or an adjustable spring force to keep the valve closed under the desired relief pressure and open when the pressure of the gas goes beyond the pre-set level; see for example, FIGS. 3 and 4. The burst disc is a low cost solution due to its simple structure, while the more complex spring-loaded pressure relief valve provides repeatable use as it automatically closes when the pressure drops back to normal after release of some of the pressurized gas. Examples of known burst disc designs include those disclosed in U.S. Pat. No. #4,590,957, issued 27 May 1986 to McFariane, and U.S. Pat. No. #4,385,710, issued 31 May 1983 to Kurihara and Mori. A typical spring-loaded pressure relief valve design is disclosed in U.S. Pat. No. #6,736,162 B2, issued 18 May 2004 to Schimnowski et al. Many other designs can be found again from the product catalog High Pressure Equipment Company (http://www.high-pressure.com/index.asp).

The inlet connector 4, quick-connect detach outlet connector 3 and safety pressure relief device 7 can be either built directly on the body of the valve 10, or screwed onto the body of the valve 10, or attached to the body of the valve 10 by any physical means (welding, bonding, etc.).

The valve assembly 100 is expected to be particularly useful to connect MHHS canisters 9 with fuel cell systems (not shown). Therefore, the valve assembly 100 components, in particular, the valve 2, outlet connector 3, inlet connector 4, pressure relief device 7, knob 5, knob guard 6, and body 10 are made of materials that are known to minimize damage to and performance degradation of fuel cell components, especially membrane and catalyst materials used in proton exchange membrane type fuel cells. Such materials are apparent to a person skilled in the art, and include for example, stainless steel 316.

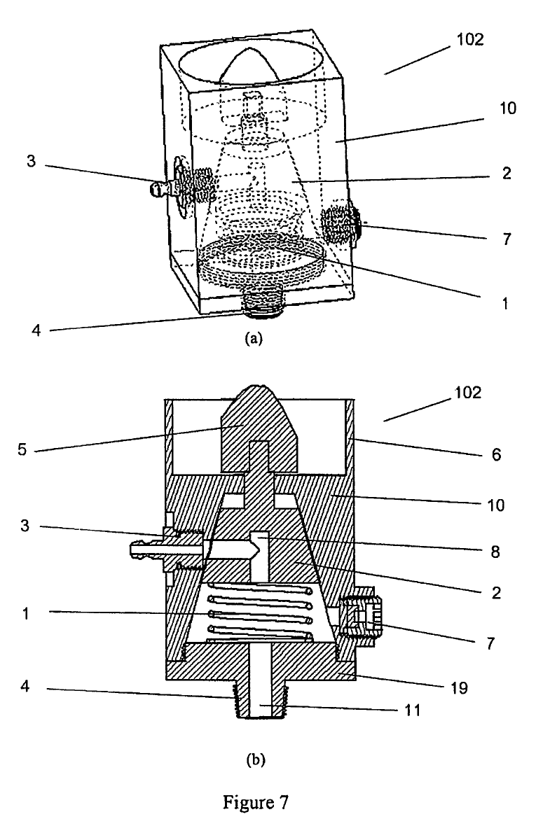

Referring now to FIG. 7 and according to a second embodiment of the invention, a valve assembly 102 is provided that is similar to the first embodiment, except that the valve 2 direction is reversed, i.e. the narrow end of the valve 2 faces the top of the body 10, and the cavity is configured to match the valve 2 with the cavity's narrow end also facing the top of the body 10. Other differences include: the knob 5 extends from the narrow end of the valve 2, the knob guard 6 is integral with the body 10, a bottom cap 19 is screwed or attached by other means to the bottom of the body 10 and closes the cavity, and the inlet connector 4 extends downwards from the bottom of the bottom cap 19. Also, the compression spring 1 is located between the bottom cap 19 and the wide end of the valve 2, and serves to apply pressure to the valve 2 to seal the valve 2 against the cavity surface. The gas conduit 11 extends from the inlet connector 4, through the bottom cap 19 and into the cavity. The L shaped gas passage 8 extends from the wide end of the valve 2, upwards into the body of the valve 2, and outwards to the side of the valve, and can be aligned in an open position with the outlet connector 3. When so aligned, gas can flow from the bottle 9 (not shown in FIG. 7), through the inlet connector 4, the gas conduit 11, into the cavity and past the compression spring 1, into the gas passage 8, and out of the assembly 102 through the outlet connector 3. The knob 5 can be rotated into a closed position, by rotating the valve 2 such that the passage 8 is not aligned with the outlet connector 4. As the pressure relief device 7 is in continuous gas communication with the cavity, its operation is independent of the position of the valve 2. The knob guard 6 protects the knob 5 from accidental opening by impacts.

The second embodiment of the assembly 102 is particularly usefully as it enables a gas-tight seal even if the spring 1 fails, as gas pressure from the bottle 9 will bias the valve 2 against the cavity surface.

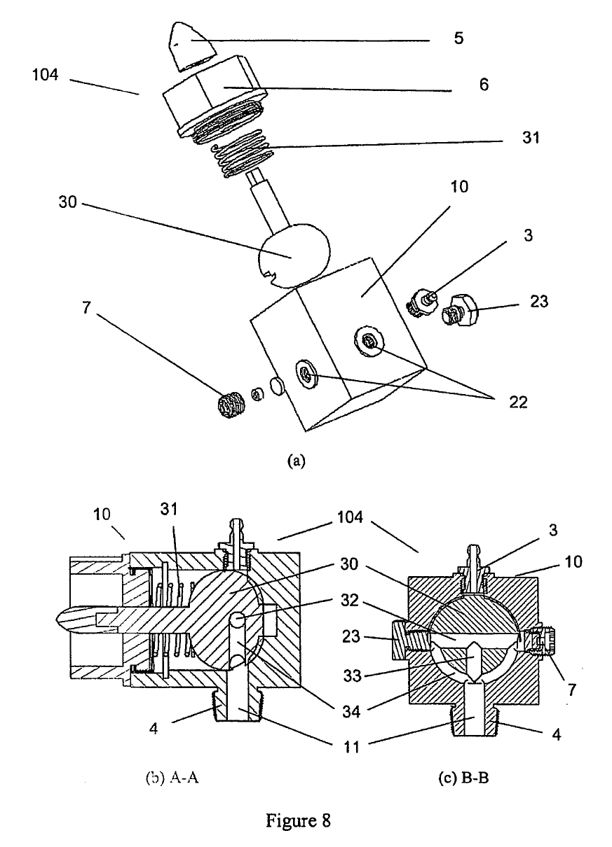

Referring now to FIGS. 8(a) to (c) and according to a third embodiment of the invention, a valve assembly 104 is provided which is similar to the first embodiment except that the valve 30 a generally spherical shape, and the cavity extends laterally across the body 10 and has a generally hemispherical end that matches the shape of the valve 30. Also, the outlet connector 3 extends outwardly from the top of the body 10, and the knob 5 extends outwardly from the side of the valve 30 and through the knob guard 6, which is on or mounted to the side of the body 10 and serves to close the cavity. A compression spring 31 is located between the knob guard 6 and the valve 30 to bias the valve 30 against the cavity and establish a gas-tight seal therebetween.

A pair of blind openings 22 are provided on opposite sides of the body 10; both extend into parts of the cavity in contact with the valve 30. One blind opening 22 is closed by a blank 23, and the other blind opening 22 is fitted with a burst disk-type pressure relief device 7. Alternatively, the positions of the blank 23 and pressure relief device 7 can be reversed. The gas conduit 11 extends though the inlet connector 4 to the part of the cavity in contact with the valve 30. A first horizontal gas passage 32 extends through the valve 30; the valve 30 can be rotated such that the two ends of the gas passage 32 are aligned with the gas conduit 11/inlet connector 4 and the outlet connector 3 in an open position (the valve 2 is shown in the closed position in Figures (b) and (c)).

Optionally, a second horizontal gas passage 33 is provided in the valve 30 that intersects the first horizontal gas passage 32 and is aligned with the pressure relief device 7 when the valve 2 is in the open position. The second horizontal gas passage 33 enables the pressure relief device 7 to operate when the valve 30 is in the open position, as gas flowing from the inlet connector 4 is in gaseous communication with the pressure relief device 7. Alternatively or additionally, a groove 34 is provided in the surface of the valve 30 with an arc-length that extends about 180° around the circumference of the valve 30 and is positioned on the valve 30 such that the inlet connector 4 is in continuous gaseous communication with the pressure relief device 7 over the arc-length. The valve's open position is within this arc-angle, so the pressure relief device 7 is operable when the valve 30 is in the open position, as well as when the valve 30 is in a closed position anywhere along the arc-angle.

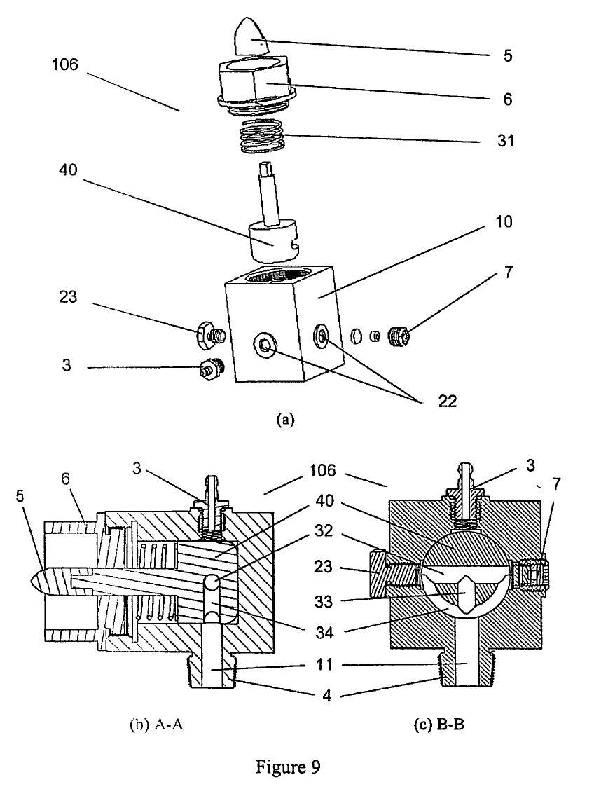

Referring to FIGS. 9(a) to (c) and according to a fourth embodiment of the invention, a valve assembly 106 is provided that is similar to the third embodiment except that a valve 40 is provided that has a generally cylindrical shape, and the cavity within the body 10 has a matching cylindrical shape. Like the third embodiment, a groove 34 is provided on surface of the valve 40 that enables continuous gaseous communication between the inlet connector 4 and the pressure relief device 7 when these two components are within the arc-length of the groove 34.

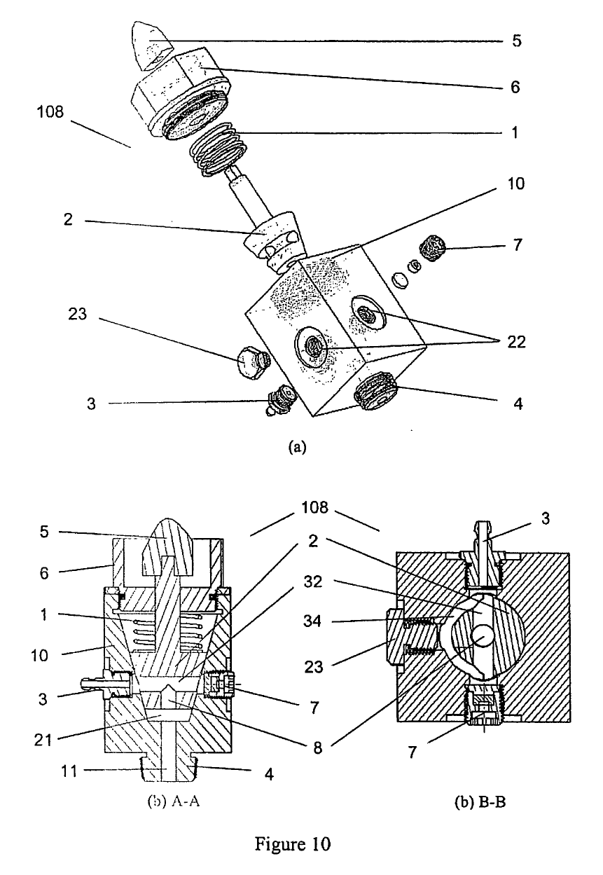

The grooved valve design can also be implemented with the frusta-conical valve 2 as used in the first and second embodiments, as all four valve designs (upwardly facing frusta conical, downwardly facing frusta-conical, spherical, and cylindrical) have a circular cross-section when viewed from the rotation axis of the valve 2, 30, 40. With such a grooved valve 2, 30, 40, the pressure relief device 7 does not have to communicate with an open space in the cavity between the valve 2 and inlet connector 4 to enable continuous gas flow from the inlet connector 4 to the pressure relief device 3. For example, in a fifth embodiment and as shown in FIG. 10, a valve assembly 108 based on the first embodiment is provided having a grooved valve 2 and multiple blind openings 22. With the grooved valve 2, the multiple blind openings 22 can be provided at the same height around the side of the body 10, i.e. at a height that communicates with the surface of the valve 2. The pressure relief device 7, outlet connector 3, and blank 23 can thus be interchangeably fitted to any of these blind openings 22, which offers design flexibility to the valve assembly 100. The gas passage 8 extends upwards from the narrow end of the valve 2 and intersects the first horizontal gas passage 32 which spans the diameter of the valve 2; when the valve 2 is rotated into an open position (as shown in FIGS. 10(b) and (c)), the gas passages 8, 32 provide gas communication between the outlet connector 3, inlet connector 4 and the pressure relief device 7. Optionally, a second horizontal gas passage 33 can be provided that extends perpendicularly from the first horizontal gas passage 32 to provide gas communication with the blind opening 22 presently filled with the blank 23. The valve 2 can be rotated clockwise over an angle of 180 degrees to close the valve 2 but retain gas communication between the inlet connector 4 and the pressure relief device 7 via the groove 34, which has an arc-length that spans about 180 degrees.

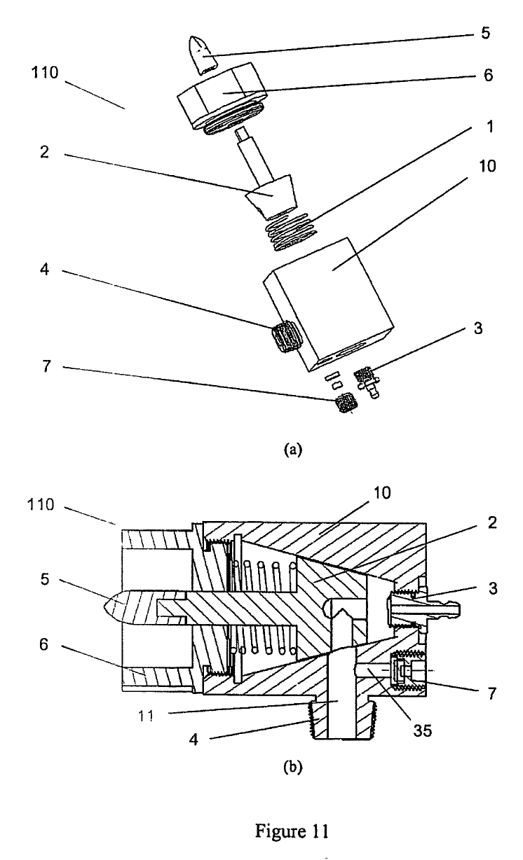

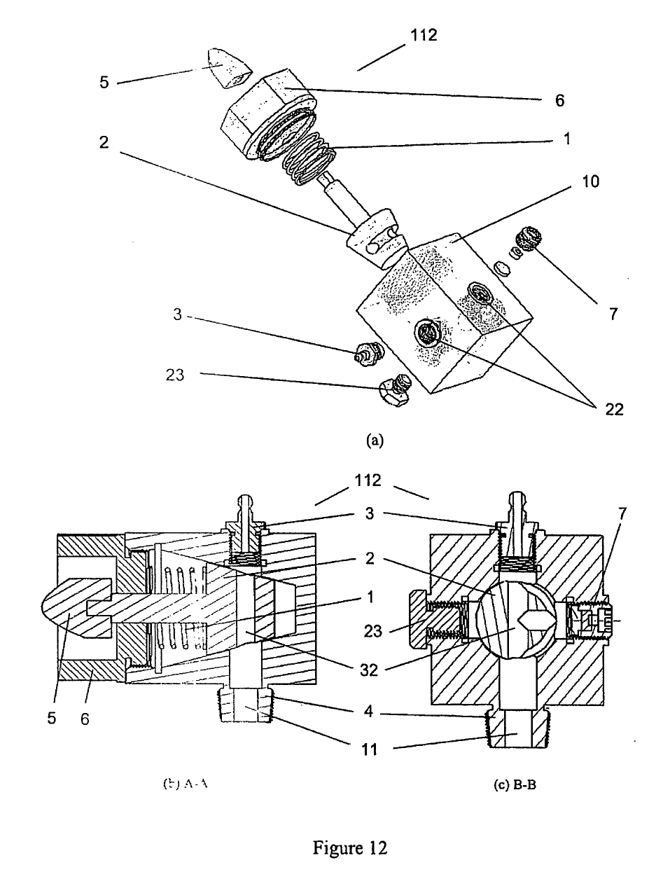

Referring to FIGS. 11 to 12, and according to alternative embodiments of the invention, the positions of the knob 5 and valve 2, inlet connector 4, outlet connector 3, and pressure relief valve 7 can be modified to produce a valve assembly 2 to suit different applications. For example, in FIGS. 11(a) and (b), a valve assembly 110 is provided with a frusta-conical valve 2 like the one used in the first embodiment, but with the control knob 5 and valve 2 extending along the side of the body 10, and with the outlet connector 3 and the pressure relief device 7 on or mounted to the side of the body 10. In this embodiment, a pressure relief gas conduit 35 is provided that intersects the gas conduit 11 extending through the inlet connector 4, to provide continuous gaseous communication between the inlet connector 4 and the pressure relief device 7. In FIGS. 12 (a) and (b), a valve assembly 112 is provided with a frusta-conical valve 2 like the one used in the first embodiment, but with the control knob 5 and valve 2 extending along the side of the body 10, with the outlet connector 3 on or mounted to the top of the body, and with two blind openings 22 provided in the side of the body in which the pressure relief device 7 and the blank 23 are installed.

Modifications, variations and adaptations may be made to the particular embodiment of the invention described above without departing from the scope of the invention, which is defined in the claims.

What is claimed is:

1. A gas shut-off valve assembly comprising:
(a) a body having a cavity therein;
(b) an inlet connector on the body and in gas communication with the cavity, the inlet connector being connectable to a pressurized gas storage device;
(c) an outlet connector on the body and in gas communication with the cavity, the outlet connector including a first valve biased to remain closed when external pressure thereon is less than or equal to ambient pressure, thereby impeding at least atmospheric gas backflow into the cavity;
(d) a shut-off valve located inside the cavity that is movable between an opened position that permits gas flow between the inlet and outlet connectors, and a closed position that denies gas flow between the inlet and outlet connectors.

2. The valve assembly of claim 1 wherein the outlet connector is configured to connect to an external device having a specified internal operating pressure, and the first valve is biased to remain closed when external pressure is less than or equal to the external device operating pressure, thereby preventing backflow of gas from inside the external device.

3. The valve assembly of claim 1 wherein the shut-off valve has a circular cross-section with an axis around which the valve is rotatable between the opened and closed positions.

4. The valve assembly of claim 3 wherein the shut-off valve has a conical or frusta-conical shape with an axis coaxial with the rotation axis, and at least part of the cavity has a shape corresponding to the shut-off valve shape.

5. The valve assembly of claim 4 wherein narrow ends of the shut-off valve and the cavity face upstream of the gas flow.

6. The valve assembly of claim 5 wherein wide ends of the shut-off valve and the cavity face upstream of the gas flow.

7. The valve assembly of claim 3 wherein the shut-off valve has a generally spherical shape and at least part of the cavity has a shape corresponding to the shut-off valve shape.

8. The valve assembly of claim 3 wherein the shut-off valve has a generally cylindrical shape with an axis coaxial to the rotation axis, and at least part of the cavity has a shape corresponding to the shut-off valve shape.

9. The valve assembly as claimed in claim 3 further comprising a knob attached to and for rotating the shut-off valve, the knob being marked to indicate when the shut-off valve is in an opened or closed position

10. The valve assembly as claimed in claim 9 wherein the knob is surrounded by a knob guard to prevent accidental opening of the valve or to give protection to the valve knob and stem.

11. The valve assembly of claim 1 wherein the outlet connector further comprises a quick connect/detach mechanism for connecting to the external device.

12. The valve assembly of claim 11 wherein the outlet connector further comprises a second valve located between the cavity and the first valve, and being a one way valve configured to allow gas flow out of the outlet connector only.

13. The valve assembly of claim 12 wherein the outlet connector further comprises a bypass mechanism for receiving a charging gas, the bypass mechanism comprising a bypass gas channel in gas communication with the cavity, and a bypass valve biased to close the bypass gas channel.

14. The valve assembly of claim 1 further comprising a spring biasing the shut-off valve against the cavity thus establishing a fluid seal therebetween.

15. The valve assembly of claim 1 further comprising a pressure relief device on the body and in gas communication with the inlet connector.

16. The valve assembly of claim 15 wherein the pressure relief device is a burst disk that is designed to burst when the pressure inside the valve assembly exceeds a threshold pressure.

17. The valve assembly of claim 15 wherein the pressure relief device is a spring-loaded valve calibrated to open when the pressure inside the valve assembly exceeds a threshold pressure.

18. The valve assembly of claim 15 wherein the pressure relief device is in gas communication with a part of the cavity between the shut-off valve and the inlet connector, thereby being in continuous gas communication with the inlet connector.

19. The valve assembly of claim 15 wherein the shut-off valve has a circular cross-section with an axis around which the valve is rotatable between the opened and closed positions, the shut-off valve further includes a groove extending along a surface of the valve, the groove being alignable with the pressure relief device and inlet connector to provide gas communication therebetween.

20. The valve assembly of claim 15 wherein the shut-off valve has a circular cross-section with an axis around which the valve is rotatable between the opened and closed positions, and the valve assembly further comprises a knob mounted to the shut-off valve and that can be manipulated to rotate the shut-off valve.

21. The valve assembly of claim 20 wherein the inlet connector is on or mounted to a bottom of the body and outlet connector and pressure relief device are on or mounted to a side of the body, and the shut-off valve rotation axis is vertical.

22. The valve assembly of claim 20 wherein the inlet connector is on or mounted to a bottom of a body, the outlet connector is on or mounted to a top of the body, the pressure relief device is on or mounted to a side of the body, and the shut-off valve rotation axis is horizontal.

23. The valve assembly of claim 20 wherein the inlet connector is at the bottom of the body, the outlet connector and pressure relief device are on a side of the body, and the shut-off valve rotation axis is horizontal.

24. The valve assembly of claim 1 wherein the gas storage device is a metal hydride hydrogen storage canister or a chemical hydride hydrogen storage canister.

25. A gas shut-off valve assembly comprising:
(a) a body having a cavity therein;
(b) an inlet connector on the body and in gas communication with the cavity, the inlet connector being connectable to a pressurized gas storage device;
(c) an outlet connector on the body and in gas communication with the cavity, the outlet connector including a first valve biased to remain closed when external pressure thereon is less than or equal to ambient pressure, thereby impeding at least atmospheric gas backflow into the cavity; and
(d) a conical or frusta-conical shutoff valve located inside the cavity that is rotatable between an opened position that permits gas flow between the inlet and outlet connectors, and a closed position that denies gas flow between the inlet and outlet connectors.

26. The valve assembly of claim 25 wherein at least part of the cavity conforms to the valve shape, and wide ends of the valve and cavity face upstream of the gas flow.

27. A gas shut-off valve assembly comprising:
(a) a body having a cavity therein;
(b) an inlet connector on the body and in gas communication with the cavity, the inlet connector being connectable to a pressurized gas storage device;
(c) an outlet connector on the body and in gas communication with the cavity, the outlet connector including a first valve biased to remain closed when external pressure thereon is less than or equal to ambient pressure, thereby impeding at least atmospheric gas backflow into the cavity; and
(d) a shut-off valve located inside the cavity and having a circular cross-section with an axis around which the valve is rotatable between the opened and closed positions, and a groove on the surface of the valve that is aligned with the inlet and outlet connectors to permit gas flow therebetween when the shut-off valve is in the opened position, and is not aligned with the inlet and outlet connectors to deny gas flow therebetween when the valve is in the closed position.

28. The valve assembly of claim 27 wherein the shut-off valve has a conical or frusta-conical shape with an axis coaxial with the rotation axis, and the groove extends partly around the circumference of the valve surface.

29. The valve assembly of claim 27 wherein the shut-off valve has a generally spherical shape and the groove extends partly around the circumference of the valve surface.

30. The valve assembly of claim 27 wherein the shut-off valve has a generally cylindrical shape and the groove extends partly around the circumference of the valve surface.

31. The valve assembly of claim 27 further comprising a pressure relief device on or mounted to the body and in gaseous communication with the groove when the valve is in the opened or closed positions.

32. A hydrogen gas storage apparatus comprising:
(a) a metal hydride storage device having an orifice and configured to store gaseous hydrogen; and
(b) a valve assembly comprising:
(i) a body having a cavity therein;
(ii) an inlet on the body and in gas communication with the cavity and the storage device;
(iii) an outlet connector on the body and in gas communication with the cavity, the outlet connector including a first valve biased to remain closed when external pressure thereon is less than or equal to ambient pressure, thereby impeding at least atmospheric gas backflow into the cavity; and
(iv) a shut-off valve located inside the cavity that is movable between an opened position that permits gas flow between the inlet and outlet connectors, and a closed position that denies gas flow between the inlet and outlet connectors.

33. The apparatus as claimed in claim 33 further comprising a gas permeable filter between the metal hydride containing canister and the valve assembly for stopping metal hydride materials escaping from the canister.
